(19) United States
(12) Patent Application Publication
(10) Pub. No.: US 2007/0251877 A1
(43) Pub. Date: Nov. 1, 2007

(54) Element and structure for piping

(76) Inventors: Ta-Teh Chang, Jhongli City (TW); Po-Lin Chen, Jhongli City (TW); Chia-Hao Chang, Jhongli City (TW)

Correspondence Address: Raymond Y. Chan, Suite 128, 108 N. Ynez Avenue, Monterey Park, CA, 91754, US

(21) Appl. No.: 11/413,760

(22) Filed: Apr. 27, 2006

(51) Int. Cl. B01D 29/00

(52) U.S. Cl. 210/338; 210/459; 138/114

(57) ABSTRACT

A pipe element structure comprises a pipe body which comprises an exterior pipe, an intermediate filtration pipe and an interior filtration pipe. The exterior pipe has multiple openings on its surface. The intermediate and interior filtration pipes are made of porous materials. As the pipe body being buried in the ground, the exterior pipe filters out soils in bigger particle size by the openings whereas allows soil and water to sink in, and piles up effectively inside. The intermediate filtration pipe filters out the soil-water to isolate soil particles. The water is filtrated down into the interior filtration pipe free of blocking or clogging.

### BACKGROUND OF THE PRESENT INVENTION

1. Field of Invention

The present invention relates to a pipe element structure, specifically to a pipe element structure making use of an exterior pipe through exposing in full to soils that prevents an intermediate filtration pipe and an interior filtration pipe from damage during laying down and burying the pipe body. The soils in larger particle size are segregated by the exterior pipe while soil mass is filtered and water flows down into the interior filtration pipe free of blockage.

2. Description of Related Arts

In the fields of civil and hydraulic engineering, environments relating to soils and rocks have their engineering structures that involve works as excavating and filling, which gives rise to facilities as highways, roads and embankments; for instance, slopes formed by surrounding soils and rocks or embankments and retaining construction formed by reinforcement, or larger areas of pavements and roads as airport. However, in the fields of civil and hydraulic engineering, it is “water” that has serious influence from time to time. Drainage systems thus play an important role in civil and hydraulic engineering or related constructions. A poor drainage system would deteriorate the original design and substantially decrease life time. Moreover, once the drainage system fails to carry out draining thoroughly, the slope is became unstable, possibly a sliding, which in turn arises destructions in structure as pavement rutting, settling, cracking and pumping, where the anticipated situation to be faced is not just partial maintenance but entire repair.

In order to improve the foregoing defects, engineering groups worked in construction presently employ the drainage system according to the variances in usage conditions and environments to reinforce the draining strength and effectively eliminating water pressure, which assures the safety of work facilities. The drainage system once in construction is by way of drilling holes or digging troughs, followed by pushing the prefabricated drain pipes into the holes or placing them into the troughs for the desirable drainage. During the process of pushing down the drain pipe, let it be a geosynthetic wrapped pipe, a prefabricated combination pipe, a complex drain pipe, or a ripple drain pipe, the surface of the pipe may obstruct or break when being laid or buried. The pipe is then not available for flushing or replacement and fails to achieve the expected drainage, once the drainage system suffers from malfunction or collapse.

It is apparent that the prior articles have many defects and are not preferred designs. There is indeed considerable room for improvement.

### SUMMARY OF THE PRESENT INVENTION

It is an object of the present invention to provide a pipe element structure by the use of an exterior pipe to protect an intermediate filtration pipe and an interior filtration pipe from being compressed into deformation that influences the drainage.

It is another object of the present invention to provide a pipe element structure that the intermediate and interior filtration pipes can be extracted from the exterior pipe, enabling the two filtration pipes to be replaced and backwashed later.

It is a further object of the present invention to provide a pipe element structure that the exterior pipe has openings on its surface where the opening size is adjustable, subject to the aggregate soils of the site of piping work; as a consequence, the soils larger in particle size are set apart while allowing the soils small in particle size into the pipe, to form a mixture of water and soil particles inside the exterior pipe.

It is still a further object of the present invention to provide a pipe element structure by applying a structure of integrating the intermediate filtration pipe and the interior filtration pipe to effectively isolate the mixture of soil particles and water, then with particles of soils and percolate water down into the interior filtration pipe, free of blocking or clogging.

In order to accomplish the above objects, the present invention provides a pipe element structure, comprising a pipe body which comprises an exterior pipe, an intermediate filtration pipe and an interior filtration pipe. The exterior pipe has multiple openings allowing small-particle soils mixed with water to enter. The intermediate filtration pipe and the interior filtration pipe are made of porous material and integrate into a single pipe percolator capable of being extracted from the exterior pipe for replacement and flushing. When laying down and burying the pipe body in the ground, it utilizes the effective shielding of the exterior pipe in contact with the soils to protect the intermediate and interior filtration pipes from damage and also to filter out soils in bigger particle size by the openings on the exterior pipe. Meanwhile, the exterior pipe allows the slurry and water to sink in and pile up effectively. The intermediate filtration pipe filters out the slurry to achieve isolating soil particles. The water is filtrated down into the interior filtration pipe, free of blockage for the best drainage.

These features and advantages of the present invention will be fully understood and appreciated from the following detailed description of the accompanying Drawings.

These and other objectives, features, and advantages of the present invention will become apparent from the following detailed description, the accompanying drawings, and the appended claims.

### BRIEF DESCRIPTION OF THE DRAWINGS

FIG. 1 is a three dimensional view of the pipe element structure according to the present invention.

FIG. 2 is a cross-sectional view of the pipe element structure according to the present invention.

FIG. 3 is an assembly schematic diagram of the pipe element structure according to the present invention.

FIG. 4 is a sectional view of an embodiment of the pipe element structure according to the present invention.

FIG. 5 is a sectional view of another embodiment of the pipe element structure according to the present invention.

### DETAILED DESCRIPTION OF THE PREFERRED EMBODIMENT

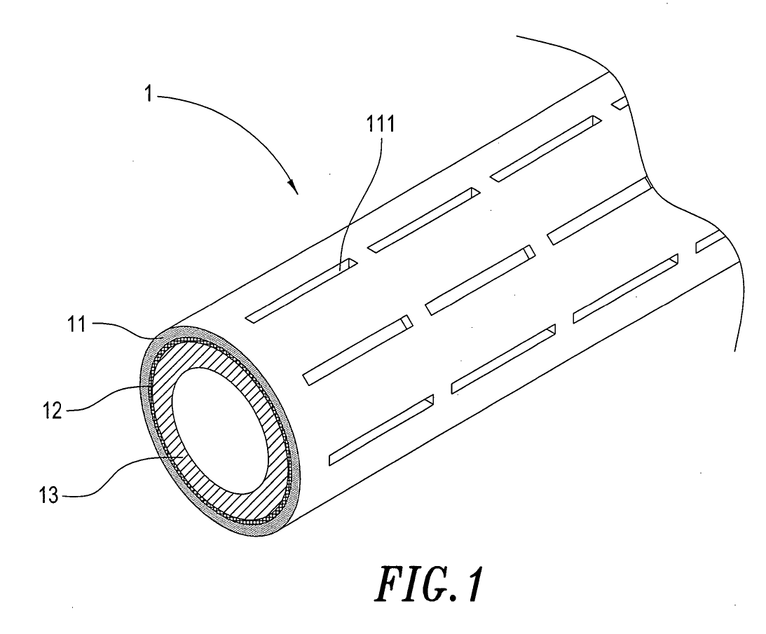

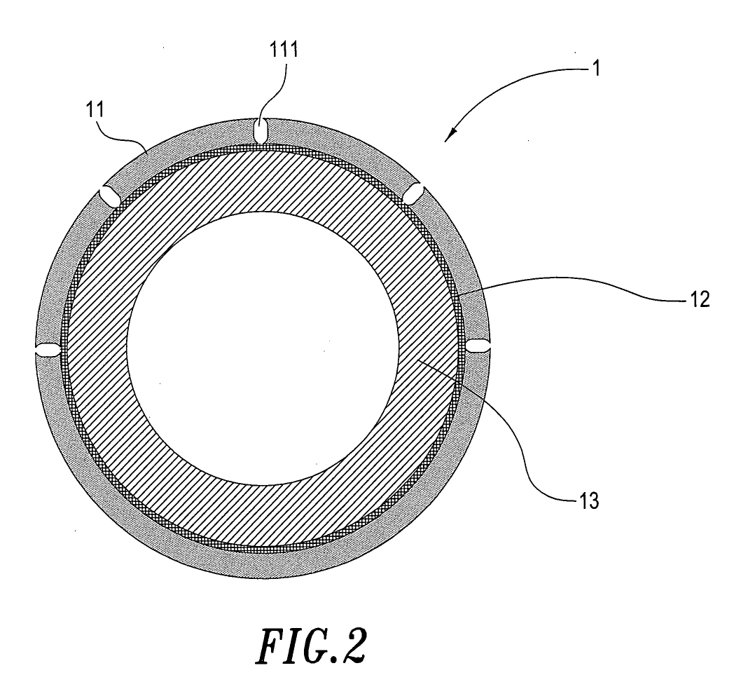

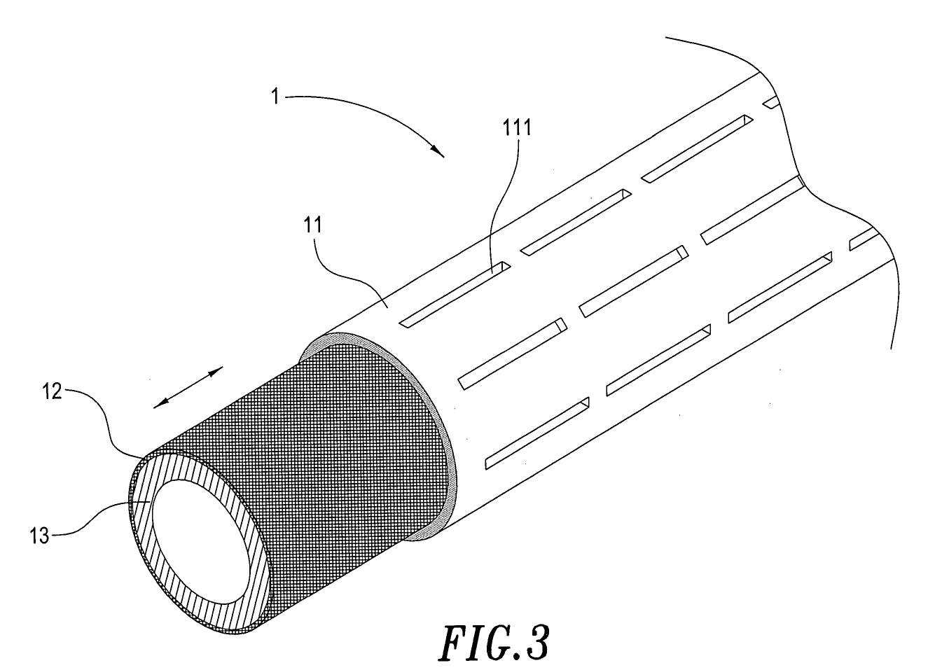

FIG. 1 is a three dimensional view of the pipe element structure according to the present invention. FIG. 2 is a cross-sectional view of the pipe element structure according to the present invention. FIG. 3 is an assembly schematic diagram of the pipe element structure according to the present invention. Referring to FIG. 1 to FIG. 3, the schematic views describe the pipe element structure according to the present invention comprising a pipe body 1 which comprises an exterior pipe 11, an intermediate filtration pipe 12 and an interior filtration pipe 13.

The exterior pipe 11 has multiple openings 111 on its outer surface which can be bar-like or other shape holes wherein the diameter of the openings 111 is adjustable, subject to the aggregate soils of the site of piping work, such that the soils larger in particle size are set apart while allowing the small particle soils into the exterior pipe 11, to form a mixture of water and soils inside the exterior pipe 11. The exterior pipe 11 has element and specification of the common types such as plastic material pipe, high compression-resistant or strike durable pipe (for instance: PVC, PE, U-PVC, HIB etc. pipes).

The intermediate filtration pipe 12 and the interior filtration pipe 13 are integrated into a single percolator. Both intermediate filtration pipe 12 and the interior filtration pipe 13 are made of porous, blockage-resistant materials such as off-the-shelf stiff non-woven porous strengthened pipeline and the like. The intermediate 12 and the interior 13 are positioned in the exterior pipe 11, wherein a gap is kept in between the intermediate 12 and the exterior pipe 11 to ease assemblage and extraction of the intermediate 12 and the interior 13 from the exterior pipe 11 (referring to FIG. 3) for the purpose of the replacement and backwashing of the intermediate filtration pipe 12 and the interior filtration pipe 13.

The pipe element structure of the present invention is thus formed through the foregoing combination procedure.

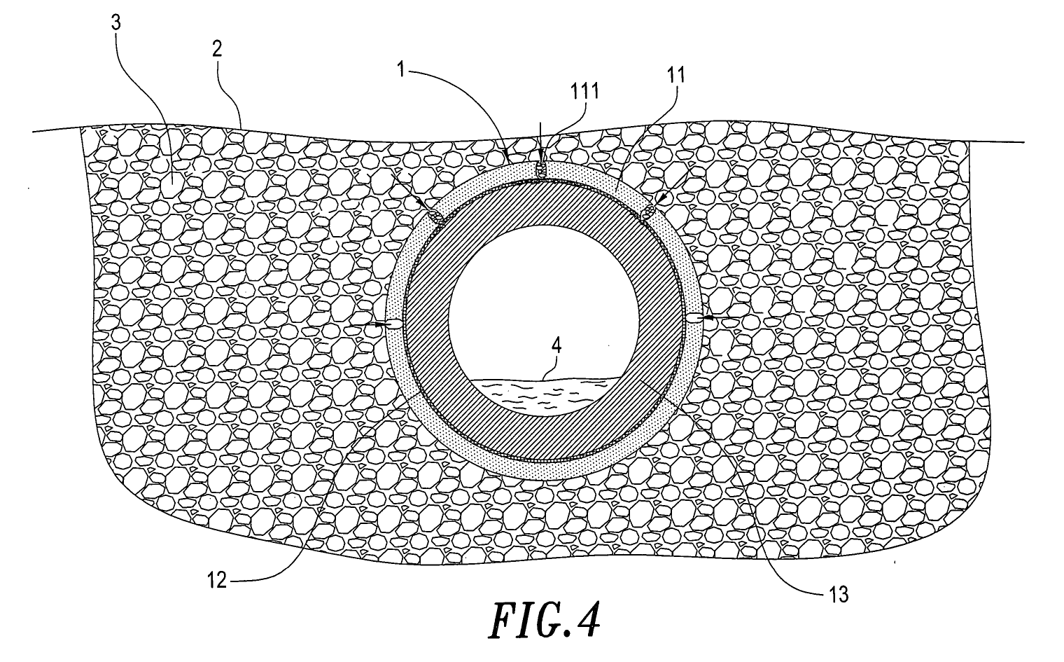

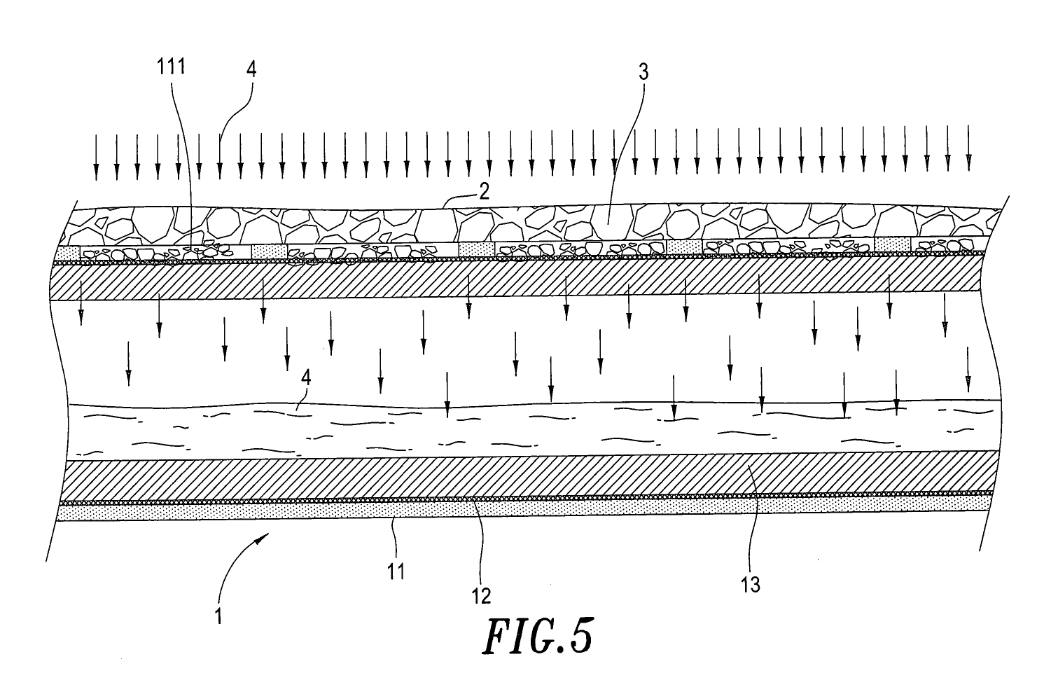

FIG. 4 is a sectional view of an embodiment of the pipe element structure according to the present invention. FIG. 5 is a sectional view of another embodiment of the pipe element structure according to the present invention. Referring to FIG. 4 and FIG. 5, the drawings are the schematics of embodiments according to the present invention. When laying down and burying the pipe body 1 in the ground 2, it utilizes the effective shielding of the exterior pipe 11 in contact with the soils 3 to protect the intermediate filtration pipe 12 and interior filtration pipe 13 from damage. The purpose is to make sure that the exterior pipe 11 effectively protects the intermediate filtration pipe 12 and interior filtration pipe 13 from being disabled in filtration. As the pipe body 1 is buried in the ground, the exterior pipe 11 filters out soils in bigger particle size (example: stones) by the openings 111 on its outer surface while allowing slurry and water to sink in and pile up effectively between itself and the intermediate filtration pipe 12. The intermediate filtration pipe 12 filters out the slurry to isolate soil particles. The water 4 is filtrated down into the interior filtration pipe 13 free of blockage for the best drainage of water 4. The intermediate filtration pipe 12 and interior filtration pipe 13 can be extracted from the exterior pipe 11 for replacement and backwashing, capable of saving costs by repeated usage.

The pipe element structure according to the present invention, comparing to the prior art, has the following advantages:

1. The present invention is to make use of an exterior pipe 11 to protect an intermediate filtration pipe 12 and an interior filtration pipe 13 from being compressed into deformation that influences the drainage.

2. The intermediate filtration pipe 12 and the interior filtration pipe 13 of the present invention can be extracted from the exterior pipe 11, which enables the intermediate filtration pipe 12 and the interior filtration pipe 13 to be replaced and backwashed for repeated usage.

3. The exterior pipe 11 of the present invention has openings 111 on its outer surface where the diameter is adjustable, subject to the aggregate soils of the site of piping work; as a consequence, the soils larger in particle size are set apart while allowing the small particle soils into the pipe 11, to form a mixture of water and slurry in between the exterior pipe 11 and the intermediate filtration pipe 12.

4. The present invention applies a structure of integrating the intermediate filtration pipe 12 and the interior filtration pipe 13 to effectively percolate water down through the slurry formed by particles of soils into the interior filtration pipe 13 free of blockage for the preferred drainage.

Many changes and modifications in the above described embodiments of the invention can, of course, be carried out without departing from the scope thereof. Accordingly, to promote the progress in science and the useful arts, the invention is disclosed and in intended to be limited only by the scope of the appended claims.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pipe element structure, comprising a pipe body which comprises:
an exterior pipe, having multiple openings thereon;
an intermediate filtration pipe; and
an interior filtration pipe, wherein said intermediate filtration pipe and said interior filtration pipe are positioned in said exterior pipe, and a gap is kept in between the intermediate filtration pipe and the exterior pipe to ease assemblage of the intermediate filtration pipe and the interior pipe into the exterior pipe and extraction thereof from the exterior pipe.

2. The pipe element structure, as recited in claim 1, wherein said openings on said exterior pipe has a predetermined shape selected from a group consisting of belt and circular.

3. The pipe element structure, as recited in claim 1, wherein a size of said openings on said exterior pipe is adjustable, subject to aggregate soils of a site of piping work, such that soils larger in particle size are set apart while allowing small particle soils into said exterior pipe, to form a mixture of water and soil particles in said exterior pipe.

4. The pipe element structure, as recited in claim 1, wherein said exterior pipe can be selected from plastic material piping, high compression-resistant or strike resistance piping.

5. The pipe element structure, as recited in claim 1, wherein said intermediate filtration pipe and said interior filtration pipe has a single twin-layer structure.

6. The pipe element structure, as recited in claim 1, wherein said intermediate filtration pipe and said interior filtration pipe are made of porous, clogging-resistant materials.
